(19) United States
(12) Patent Application Publication
(10) Pub. No.: US 2026/0181670 A1
(43) Pub. Date: Jun. 25, 2026

(54) DOWNLINK CONTROL CHANNEL DESIGN AND SIGNALING

(71) Applicant: QUALCOMM Incorporated, San Diego, CA (US)

(72) Inventors: Sony AKKARAKARAN, Poway, CA (US); Tao LUO, San Diego, CA (US); Navid ABEDINI, Basking Ridge, NJ (US); Xiaoxia ZHANG, San Diego, CA (US); Juan MONTOJO, San Diego, CA (US); Junyi LI, Greentown, PA (US)

(21) Appl. No.: 19/425,876

(22) Filed: Dec. 18, 2025

Related U.S. Application Data
(60) Provisional application No. 63/738,256, filed on Dec. 23, 2024.

(51) Int. Cl. H04W 72/232

(52) U.S. Cl. CPC H04W 72/232

(57) ABSTRACT

Methods, systems, and devices for wireless communications are described. According to techniques described herein, the network may configure control channel element (CCE) size according to various resolutions. In some examples, a modulation and control scheme (MCS) table may be defined and configured for a control channel and may indicate different CCE sizes for a control channel. A control channel may be modified such that a CCE size is a fraction of or integer number of a default CCE size. The CCE size may be bandwidth or bandwidth part dependent. In some examples, a control message (e.g., a downlink control information (DCI)) message size may be reduced. For example, a subset of control content may be predefined or fixed, or may be changed dynamically, or additional control information may be retrieved via an index value (e.g., in the DCI).

### CROSS REFERENCES

The present Application for Patent claims benefit of U.S. Provisional Patent Application No. 63/738,256 by AKKARAKARAN et al., entitled “DOWNLINK CONTROL CHANNEL DESIGN AND SIGNALING,” filed Dec. 23, 2024, assigned to the assignee hereof, and expressly incorporated herein.

### FIELD OF TECHNOLOGY

The following relates to wireless communications, including downlink control channel design and signaling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling indicating a set of parameters for one or more control channels, the set of parameters including a modulation and coding scheme table for a first control channel, a quantity of resource blocks per control channel element for the first control channel, or both, receiving a control information message via the first control channel in accordance with the set of parameters, where a subset of control information corresponding to the control information message is indicated by an index value in the control information message, or is fixed and excluded from the control information message, and performing wireless communication via a shared channel in accordance with the control information message.

A UE for wireless communications is described. The UE may include one or more memories storing processor executable code, a transceiver, and one or more processors coupled with the one or more memories and the transceiver. The one or more processors may individually or collectively be operable to execute the code to cause the UE to receive control signaling indicating a set of parameters for one or more control channels, the set of parameters including a modulation and coding scheme table for a first control channel, a quantity of resource blocks per control channel element for the first control channel, or both, receive a control information message via the first control channel in accordance with the set of parameters, where a subset of control information corresponding to the control information message is indicated by an index value in the control information message, or is fixed and excluded from the control information message, and perform wireless communication via a shared channel in accordance with the control information message.

Another UE for wireless communications is described. The UE may include means for receiving control signaling indicating a set of parameters for one or more control channels, the set of parameters including a modulation and coding scheme table for a first control channel, a quantity of resource blocks per control channel element for the first control channel, or both, means for receiving a control information message via the first control channel in accordance with the set of parameters, where a subset of control information corresponding to the control information message is indicated by an index value in the control information message, or is fixed and excluded from the control information message, and means for performing wireless communication via a shared channel in accordance with the control information message.

A non-transitory computer-readable medium storing code for wireless communications is described. The code may include instructions executable by one or more processors to receive control signaling indicating a set of parameters for one or more control channels, the set of parameters including a modulation and coding scheme table for a first control channel, a quantity of resource blocks per control channel element for the first control channel, or both, receive a control information message via the first control channel in accordance with the set of parameters, where a subset of control information corresponding to the control information message is indicated by an index value in the control information message, or is fixed and excluded from the control information message, and perform wireless communication via a shared channel in accordance with the control information message.

In some examples of the method, user equipment (UEs), and non-transitory computer-readable medium described herein, the quantity of resource blocks per control channel element includes a fraction of a default control channel element size or may be indicated by the modulation and coding scheme table for the first control channel and a second control channel corresponds to the default control channel element size.

In some examples of the method, user equipment (UEs), and non-transitory computer-readable medium described herein, the quantity of resource blocks per control channel element may be configured per band or bandwidth part.

Some examples of the method, user equipment (UEs), and non-transitory computer-readable medium described herein may further include operations, features, means, or instructions for decoding the control information message and transmitting a channel quality information corresponding to the first control channel, the channel quality information including a report margin or a deficit corresponding to the decoding.

In some examples of the method, user equipment (UEs), and non-transitory computer-readable medium described herein, the subset of control information includes frequency domain resource allocation, modulation and coding scheme information, feedback information identifiers, timing offset information, or any combination thereof.

Some examples of the method, user equipment (UEs), and non-transitory computer-readable medium described herein may further include operations, features, means, or instructions for receiving or recovering the control information message via an anchor control channel corresponding to a default control channel element size, a default control information message size, or both.

In some examples of the method, user equipment (UEs), and non-transitory computer-readable medium described herein, the first control channel includes a downlink control channel, and the control information message includes a downlink control information message.

In some examples of the method, user equipment (UEs), and non-transitory computer-readable medium described herein, the first control channel includes a sidelink control channel, and the control information message includes a sidelink control information message.

A method for wireless communications by an apparatus is described. The method may include transmitting control signaling indicating a set of parameters for one or more control channels, the set of parameters including a modulation and coding scheme table for a first control channel, a quantity of resource blocks per control channel element for the first control channel, or both, transmitting a control information message via the first control channel in accordance with the set of parameters, where a subset of control information corresponding to the control information message is indicated by an index value in the control information message, or is fixed and excluded from the control information message, and performing wireless communication via a shared channel in accordance with the control information message.

An apparatus for wireless communications is described. The apparatus may include one or more memories storing processor executable code, and one or more processors coupled with the one or more memories. The one or more processors may individually or collectively be operable to execute the code to cause the apparatus to transmit control signaling indicating a set of parameters for one or more control channels, the set of parameters including a modulation and coding scheme table for a first control channel, a quantity of resource blocks per control channel element for the first control channel, or both, transmit a control information message via the first control channel in accordance with the set of parameters, where a subset of control information corresponding to the control information message is indicated by an index value in the control information message, or is fixed and excluded from the control information message, and perform wireless communication via a shared channel in accordance with the control information message.

Another apparatus for wireless communications is described. The apparatus may include means for transmitting control signaling indicating a set of parameters for one or more control channels, the set of parameters including a modulation and coding scheme table for a first control channel, a quantity of resource blocks per control channel element for the first control channel, or both, means for transmitting a control information message via the first control channel in accordance with the set of parameters, where a subset of control information corresponding to the control information message is indicated by an index value in the control information message, or is fixed and excluded from the control information message, and means for performing wireless communication via a shared channel in accordance with the control information message.

A non-transitory computer-readable medium storing code for wireless communications is described. The code may include instructions executable by one or more processors to transmit control signaling indicating a set of parameters for one or more control channels, the set of parameters including a modulation and coding scheme table for a first control channel, a quantity of resource blocks per control channel element for the first control channel, or both, transmit a control information message via the first control channel in accordance with the set of parameters, where a subset of control information corresponding to the control information message is indicated by an index value in the control information message, or is fixed and excluded from the control information message, and perform wireless communication via a shared channel in accordance with the control information message.

In some examples of the method, apparatus, and non-transitory computer-readable medium described herein, the quantity of resource blocks per control channel element includes a fraction of a default control channel element size or may be indicated by the modulation and coding scheme table for the first control channel and a second control channel corresponds to the default control channel element size.

In some examples of the method, apparatus, and non-transitory computer-readable medium described herein, the quantity of resource blocks per control channel element may be configured per band or bandwidth part.

Some examples of the method, apparatus, and non-transitory computer-readable medium described herein may further include operations, features, means, or instructions for receiving a channel quality information corresponding to the first control channel, the channel quality information including a report margin or a deficit corresponding to decoding the control information message.

In some examples of the method, apparatus, and non-transitory computer-readable medium described herein, the subset of control information includes frequency domain resource allocation, modulation and coding scheme information, feedback information identifiers, timing offset information, or any combination thereof.

Some examples of the method, apparatus, and non-transitory computer-readable medium described herein may further include operations, features, means, or instructions for transmitting the control information message via an anchor control channel corresponding to a default control channel element size, a default control information message size, or both.

In some examples of the method, apparatus, and non-transitory computer-readable medium described herein, the first control channel includes a downlink control channel, and the control information message includes a downlink control information message.

In some examples of the method, apparatus, and non-transitory computer-readable medium described herein, the first control channel includes a sidelink control channel, and the control information message includes a sidelink control information message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports downlink control channel design and signaling in accordance with one or more aspects of the present disclosure.

FIG. 2 shows an example of a wireless communications system that supports downlink control channel design and signaling in accordance with one or more aspects of the present disclosure.

FIGS. 3 and 4 show block diagrams of devices that support downlink control channel design and signaling in accordance with one or more aspects of the present disclosure.

FIG. 5 shows a block diagram of a communications manager that supports downlink control channel design and signaling in accordance with one or more aspects of the present disclosure.

FIG. 6 shows a diagram of a system including a device that supports downlink control channel design and signaling in accordance with one or more aspects of the present disclosure.

FIGS. 7 and 8 show block diagrams of devices that support downlink control channel design and signaling in accordance with one or more aspects of the present disclosure.

FIG. 9 shows a block diagram of a communications manager that supports downlink control channel design and signaling in accordance with one or more aspects of the present disclosure.

FIG. 10 shows a diagram of a system including a device that supports downlink control channel design and signaling in accordance with one or more aspects of the present disclosure.

FIGS. 11 and 12 show flowcharts illustrating methods that support downlink control channel design and signaling in accordance with one or more aspects of the present disclosure.

### DETAILED DESCRIPTION

A wireless communications system may support control signaling via one or more control channel elements (CCEs) of a control channel. The CCE size (e.g., six resource blocks (RBs)) may be fixed, and therefore unflexible. Such fixed CCE size may result in a lack of dynamism and flexibility for control signaling, resulting in inefficient use of available system resources and increased system latency. In some examples, control signaling may include a downlink control information (DCI) message, which may have a fixed size. However, some control content may be consistent across multiple messages, but may be transmitted with every DCI message, resulting in unnecessary signaling overhead. More robust DCI messages may be useful in some scenarios (e.g., at the beginning of a discontinuous reception (DRX) period, or when tracking loops have not settled), but may be unnecessary in other scenarios. However, with a fixed DCI size, the wireless communications system may not support different DCI payloads in different scenarios.

According to techniques described herein, the network may configure CCE size according to a finer resolution (e.g., instead of a fixed CCE size of six RBs). In some examples, an MCS table may be defined and configured for a control channel. The MCS table may indicate different CCE sizes for a control channel. In some examples, a control channel may be modified such that a CCE size is a fraction of a default CCE (e.g., four CCEs instead of six CCEs), or an integer number of CCEs. In some examples, the CCE size may be bandwidth or bandwidth part dependent. A wireless device (e.g., a user equipment (UE)) may transmit channel quality information (CQI) feedback for the downlink control channel, which may include a report of a margin or deficit to decoding of the control channel. In some examples, the DCI size may be reduced. For example, a subset of control content may be predefined, or fixed, or may be changed dynamically. In some examples, a small DCI may have a small payload, and additional information may be retrieved via an index value (e.g., in the DCI). In some examples, an anchor control channel may be used to adjust control content, synchronize between the transmitter and the receiver, or the like. Such techniques may be applied to any control channel (e.g., DCI in a physical downlink control channel (PDCCH) or a sidelink control information (SCI) message in a physical sidelink control channel (PSSCH)).

Aspects of the disclosure are initially described in the context of wireless communications systems. Aspects of the disclosure are further illustrated by and described with reference to apparatus diagrams, system diagrams, and flowcharts that relate to downlink control channel design and signaling.

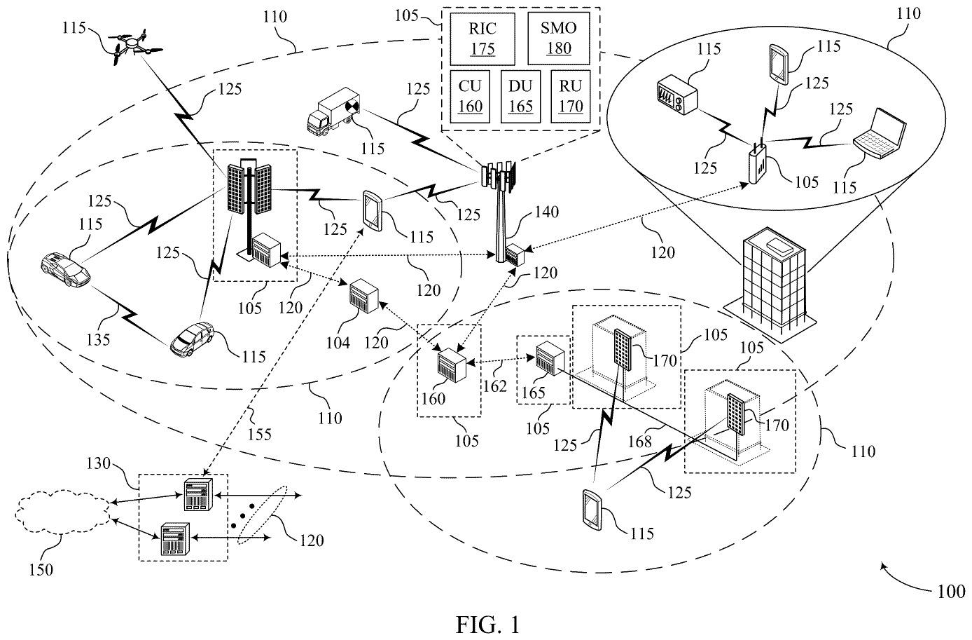

FIG. 1 shows an example of a wireless communications system 100 that supports downlink control channel design and signaling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support downlink control channel design and signaling as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

According to techniques described herein, the network may configure CCE size according to a finer resolution (e.g., instead of a fixed CCE size of six RBs). In some examples, an MCS table may be defined and configured for a control channel. The MCS table may indicate different CCE sizes for a control channel. In some examples, a control channel may be modified such that a CCE size is a fraction of a default CCE (e.g., four CCEs instead of six CCEs), or an integer number of CCEs. In some examples, the CCE size may be bandwidth or bandwidth part dependent. A wireless device (e.g., a UE 115 may transmit CQI feedback for the downlink control channel, which may include a report of a margin or deficit to decoding of the control channel. In some examples, the DCI size may be reduced. For example, a subset of control content may be predefined, or fixed, or may be changed dynamically. In some examples, a small DCI may have a small payload, and additional information may be retrieved via an index value (e.g., in the DCI). In some examples, an anchor control channel may be used to adjust control content, synchronize between the transmitter and the receiver, or the like. Such techniques may be applied to any control channel (e.g., DCI in a PDCCH or an SCI message in a PSSCH.

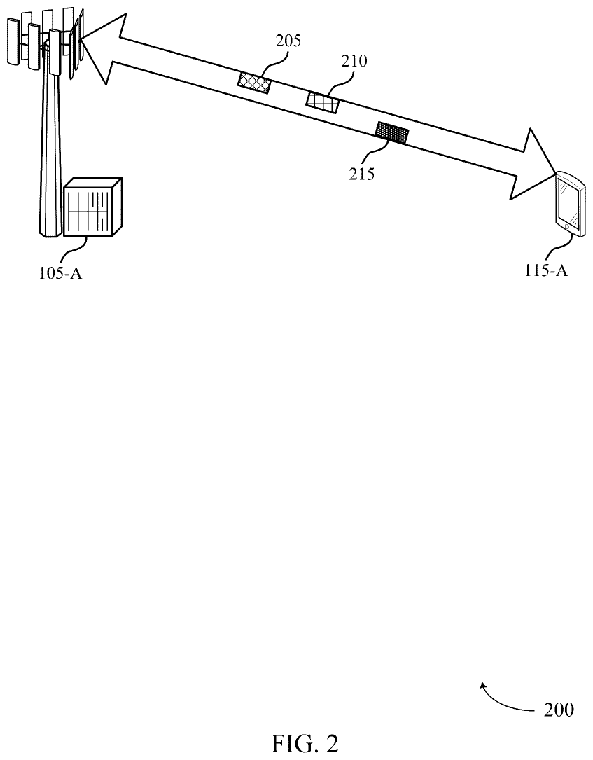

FIG. 2 shows an example of a wireless communications system 200 that supports downlink control channel design and signaling in accordance with one or more aspects of the present disclosure. The wireless communications system 200 may implement, or be implemented by, aspects of the wireless communications system 100. For example, the wireless communications system 200 may include a network entity 105-A, and a UE 115-A, which may be examples of corresponding devices described with reference to FIG. 1.

The network entity 105-A may transmit downlink control signaling via a control channel. Control signaling may be transmitted control channel elements (CCEs) of the control channel. A CCE size may be fixed (e.g., a quantity of resource blocks (RBs), such as 6 RBs). However, control signaling may be dynamic to support throughout and individual device scenarios and deployments. For example, the wireless communications system 100 may support dynamic control resource sets (CORESETs), which may enable or disable control resources in a dynamic way over time and frequency resources. Such dynamic CORESETs may increase or decrease control resources based on need. The PDCCH skipping and search space set group (SSSG) may be applied for a given control resource. The wireless communications system 200 may support dynamic control of a number of blind decoding per search space (e.g., a majority of candidates used may be a fraction of a total quantity of candidates). The wireless communications system 200 may support a finer resolution of rate matching of control resources (e.g., FDM or TDM may be used between control signaling and data signaling). In some cases, any such techniques for dynamic control signaling may be utilized to support techniques described herein, or may be utilized as part of such described techniques. For example, some information supporting dynamic signaling may be indicated by, or correspond to a control channel MCS table, or an index corresponding to fixed or preconfigured control information, or the like. The wireless communications system 200 may support hierarchical modulation for control channels, control signaling in a data region, shared reference signals between control and data signaling, channel quality information (CQI) for control channels or for control channel resource adaptation, two-step control channels, or any combination thereof.

According to techniques described herein, the network entity 105-A and the UE 115-A may communicate via a control channel according to downlink (DL) control resource utilization (e.g., at a transmitting device). In some examples, 6 RB CCEs may support a power boost compared with 4 RBs based on an equal power spectral density (PSD) transmission in some deployments. However, a fixed (e.g., non-dynamic) CCE size may be coarse (e.g., 6 RBs) in some systems, which may limit flexibility, throughput, and efficient use of available resources. Finer resource resolution for allocation control resources may be achieved as described herein.

In some examples, an MCS table may be defined for a control channel so that a finer control of control resources may be enabled. An anchor control channel may be supported in a periodic fashion, which may enable the system to avoid mismatch between transmitter and receivers. In some examples, an existing control channel may be modified. In some examples, a fraction of CCEs and/or an integer number of CCEs may be defined. In some examples, the wireless communications system may support reconfigurable CCE sizes for unicast control (e.g., which may be payload size dependent). In some examples, the wireless communications system 200 may support band dependent and/or bandwidth dependent CCE size. Lower bands may rely on increased control resource size due to anchor functionality with network energy saving (NES) features, and cross-carrier assignments may correspond to higher frequency bands.

The network entity 105-A may transmit control signaling 205 (e.g., RRC signaling, or system information) configuring the MCS table for the control channel (e.g., in which case the control message 210 or another control message may indicate an entry in the MCS table). The control signaling 205 may indicate a fixed CCE size, or the control message 210 may indicate the CCE size, or a portion of or integer of a default CCE size). The control signaling 205 may indicate the CCE size for a band, bandwidth part, or the like.

The UE 115-A may transmit a feedback message 215. The feedback message may be, or may include, CQI feedback. The CQI feedback for the downlink control channel may include a report of a margin or deficit to decoding the control channel.

In some examples, to support a more dynamic use of a control channel, the wireless communications system 200 may support a reduced DCI size, while maintaining flexibility for the transmitter. The DCI size may be reduced using control elements or content. For example, a subset of control content may be predefined, fixed or changed in a dynamic way (e.g., frequency domain resource allocation, which is a significant number of bits (e.g., about 10 bits) may be predefined or fixed, or changed over time). In some examples, a subset of control content or resources may be used for recovery of a downlink control channel in an event triggered based system. This may support radio link failure recovery, where regular control channels are lost between the transmitter and receiver. Some scheduling flexibility may be sacrificed over a short time duration. For example, MCS and frequency domain resource allocation, HARQ IDs, K0, K1, or the like, may be fixed (e.g., and therefore not included in some DCI messages).

A small payload for the downlink control channel may be used, where an index is used to retrieve control content and/or elements. Sequence based control channels may be used. In a coded payload-based channel, the decoding SNR reduction from reducing the payload size may not be dramatic due to a twenty-four bit CRC overhead in some systems.

An anchor channel may be used to adjust control content and/or synchronization between the transmitter and the receiver. The anchor channel may be a control channel (e.g., a default or legacy control channel with a default or legacy CCE size). The anchor channel may support acknowledgment such as or similar to the acknowledgement for PDCCH carrying semi-persistent scheduling (SPS) deactivation DCI. The anchor channel may be used in a nominal case instead of recovery of downlink control channels.

A more robust DCI may be used in situations where it may be more likely needed. For example, a robust (e.g., default) DCI may be used near the beginning of a DRX period, where the tracking loops (e.g., time resources, frequency resources, beams, etc.) have not settled. Such techniques may not be needed if extra reference signals and beam-sweeping are configured at the beginning, which could help the loops to converge. Such DCI usage (e.g., robust DCIs for some cases, more streamlined or smaller DCI payloads for other scenarios) may be configured by scheduler implementation (e.g., by the network entity 105-A via the control signaling 205) if the DCI payload size is dynamic.

Techniques described herein may apply to downlink signaling or sidelink signaling, among other examples. For example, although described in the Uu context (e.g., a downlink control channel), the same techniques described herein may also apply to a sidelink scenario. Sidelink control similar to downlink control may be supported, and techniques described herein may be extended to sidelink signaling (e.g., especially the case when standalone SCI is enabled). Such sidelink techniques may be especially useful for some frequency ranges (e.g., FR2). Some wireless communications systems may support two-stage control signaling (e.g., SCI1 and SCI2). When an anchor control channel and a robust control channel is supported, the wireless communications system may support a two-stage control system (e.g., making one stage more robust), or may switch to a three-stage control system. Configuration (e.g., the control signaling 205) may be performed by a UE in mode-2 type sidelink signaling operations, or by the network entity 105-A in a mode-1 type operation.

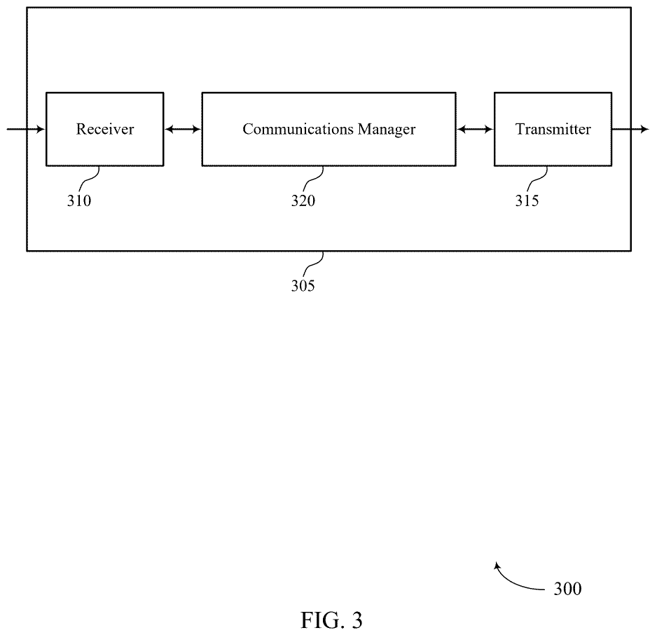

FIG. 3 shows a block diagram 300 of a device 305 that supports downlink control channel design and signaling in accordance with one or more aspects of the present disclosure. The device 305 may be an example of aspects of a UE 115 as described herein. The device 305 may include a receiver 310, a transmitter 315, and a communications manager 320. The device 305, or one or more components of the device 305 (e.g., the receiver 310, the transmitter 315, the communications manager 320), may include at least one processor, which may be coupled with at least one memory, to, individually or collectively, support or enable the described techniques. Each of these components may be in communication with one another (e.g., via one or more buses).

The receiver 310 may provide a means for receiving information such as packets, user data, control information, or any combination thereof associated with various information channels (e.g., control channels, data channels, information channels related to downlink control channel design and signaling). Information may be passed on to other components of the device 305. The receiver 310 may utilize a single antenna or a set of multiple antennas.

The transmitter 315 may provide a means for transmitting signals generated by other components of the device 305. For example, the transmitter 315 may transmit information such as packets, user data, control information, or any combination thereof associated with various information channels (e.g., control channels, data channels, information channels related to downlink control channel design and signaling). In some examples, the transmitter 315 may be co-located with a receiver 310 in a transceiver module. The transmitter 315 may utilize a single antenna or a set of multiple antennas.

The communications manager 320, the receiver 310, the transmitter 315, or various combinations or components thereof may be examples of means for performing various aspects of downlink control channel design and signaling as described herein. For example, the communications manager 320, the receiver 310, the transmitter 315, or various combinations or components thereof may be capable of performing one or more of the functions described herein.

In some examples, the communications manager 320, the receiver 310, the transmitter 315, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 320, the receiver 310, the transmitter 315, or various combinations or components thereof may be implemented in code (e.g., as communications management software or firmware) executed by at least one processor (e.g., referred to as a processor-executable code). If implemented in code executed by at least one processor, the functions of the communications manager 320, the receiver 310, the transmitter 315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 320 may be configured to perform various operations (e.g., receiving, obtaining, monitoring, outputting, transmitting) using or otherwise in cooperation with the receiver 310, the transmitter 315, or both. For example, the communications manager 320 may receive information from the receiver 310, send information to the transmitter 315, or be integrated in combination with the receiver 310, the transmitter 315, or both to obtain information, output information, or perform various other operations as described herein.

The communications manager 320 may support wireless communications in accordance with examples as disclosed herein. For example, the communications manager 320 is capable of, configured to, or operable to support a means for receiving control signaling indicating a set of parameters for one or more control channels, the set of parameters including a modulation and coding scheme table for a first control channel, a quantity of resource blocks per control channel element for the first control channel, or both. The communications manager 320 is capable of, configured to, or operable to support a means for receiving a control information message via the first control channel in accordance with the set of parameters, where a subset of control information corresponding to the control information message is indicated by an index value in the control information message, or is fixed and excluded from the control information message. The communications manager 320 is capable of, configured to, or operable to support a means for performing wireless communication via a shared channel in accordance with the control information message.

By including or configuring the communications manager 320 in accordance with examples as described herein, the device 305 (e.g., at least one processor controlling or otherwise coupled with the receiver 310, the transmitter 315, the communications manager 320, or a combination thereof) may support techniques for control signaling resulting in improved throughput, decreased system latency, reduced processing, reduced power consumption, and more efficient utilization of communication resources.

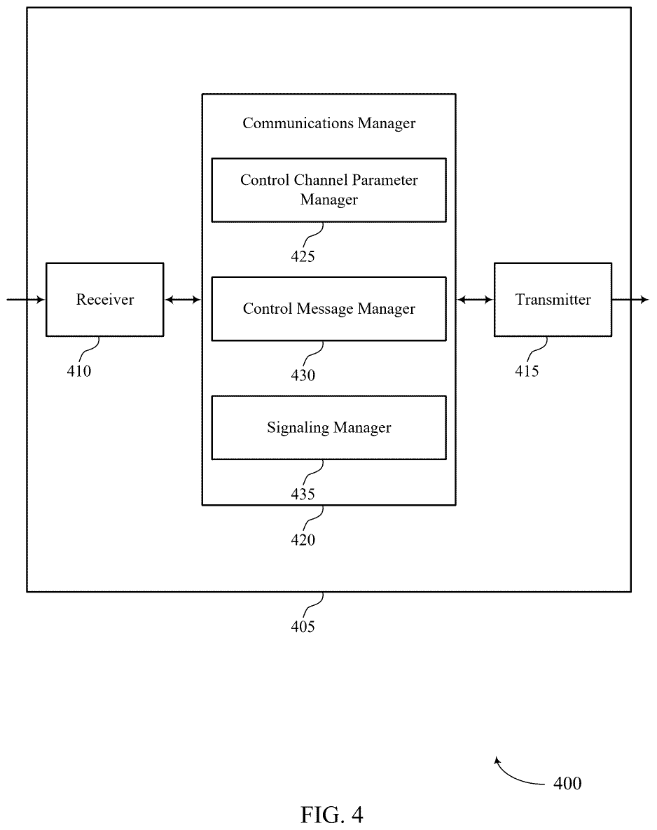

FIG. 4 shows a block diagram 400 of a device 405 that supports downlink control channel design and signaling in accordance with one or more aspects of the present disclosure. The device 405 may be an example of aspects of a device 305 or a UE 115 as described herein. The device 405 may include a receiver 410, a transmitter 415, and a communications manager 420. The device 405, or one of more components of the device 405 (e.g., the receiver 410, the transmitter 415, the communications manager 420), may include at least one processor, which may be coupled with at least one memory, to support the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to downlink control channel design and signaling). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to downlink control channel design and signaling). In some examples, the transmitter 415 may be co-located with a receiver 410 in a transceiver module. The transmitter 415 may utilize a single antenna or a set of multiple antennas.

The device 405, or various components thereof, may be an example of means for performing various aspects of downlink control channel design and signaling as described herein. For example, the communications manager 420 may include a control channel parameter manager 425, a control message manager 430, a signaling manager 435, or any combination thereof. The communications manager 420 may be an example of aspects of a communications manager 320 as described herein. In some examples, the communications manager 420, or various components thereof, may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. The control channel parameter manager 425 is capable of, configured to, or operable to support a means for receiving control signaling indicating a set of parameters for one or more control channels, the set of parameters including a modulation and coding scheme table for a first control channel, a quantity of resource blocks per control channel element for the first control channel, or both. The control message manager 430 is capable of, configured to, or operable to support a means for receiving a control information message via the first control channel in accordance with the set of parameters, where a subset of control information corresponding to the control information message is indicated by an index value in the control information message, or is fixed and excluded from the control information message. The signaling manager 435 is capable of, configured to, or operable to support a means for performing wireless communication via a shared channel in accordance with the control information message.

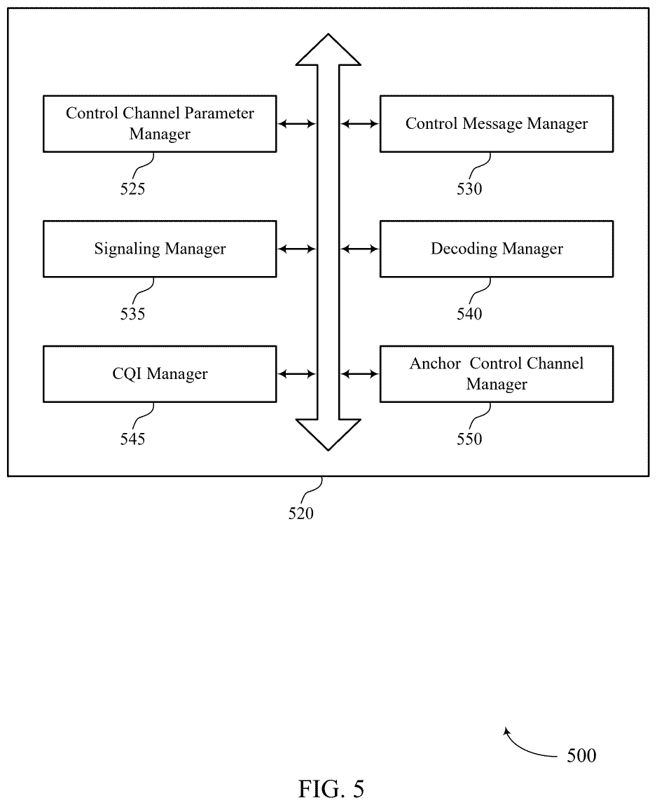

FIG. 5 shows a block diagram 500 of a communications manager 520 that supports downlink control channel design and signaling in accordance with one or more aspects of the present disclosure. The communications manager 520 may be an example of aspects of a communications manager 320, a communications manager 420, or both, as described herein. The communications manager 520, or various components thereof, may be an example of means for performing various aspects of downlink control channel design and signaling as described herein. For example, the communications manager 520 may include a control channel parameter manager 525, a control message manager 530, a signaling manager 535, a decoding manager 540, a CQI manager 545, an anchor control channel manager 550, or any combination thereof. Each of these components, or components or subcomponents thereof (e.g., one or more processors, one or more memories), may communicate, directly or indirectly, with one another (e.g., via one or more buses).

The communications manager 520 may support wireless communications in accordance with examples as disclosed herein. The control channel parameter manager 525 is capable of, configured to, or operable to support a means for receiving control signaling indicating a set of parameters for one or more control channels, the set of parameters including a modulation and coding scheme table for a first control channel, a quantity of resource blocks per control channel element for the first control channel, or both. The control message manager 530 is capable of, configured to, or operable to support a means for receiving a control information message via the first control channel in accordance with the set of parameters, where a subset of control information corresponding to the control information message is indicated by an index value in the control information message, or is fixed and excluded from the control information message. The signaling manager 535 is capable of, configured to, or operable to support a means for performing wireless communication via a shared channel in accordance with the control information message.

In some examples, the quantity of resource blocks per control channel element includes a fraction of a default control channel element size or is indicated by the modulation and coding scheme table for the first control channel. In some examples, a second control channel corresponds to the default control channel element size.

In some examples, the quantity of resource blocks per control channel element is configured per band or bandwidth part.

In some examples, the decoding manager 540 is capable of, configured to, or operable to support a means for decoding the control information message. In some examples, the CQI manager 545 is capable of, configured to, or operable to support a means for transmitting a channel quality information corresponding to the first control channel, the channel quality information including a report margin or a deficit corresponding to the decoding.

In some examples, the subset of control information includes frequency domain resource allocation, modulation and coding scheme information, feedback information identifiers, timing offset information, or any combination thereof.

In some examples, the anchor control channel manager 550 is capable of, configured to, or operable to support a means for receiving or recovering the control information message via an anchor control channel corresponding to a default control channel element size, a default control information message size, or both.

In some examples, the first control channel includes a downlink control channel, and the control information message includes a downlink control information message.

In some examples, the first control channel includes a sidelink control channel, and the control information message includes a sidelink control information message.

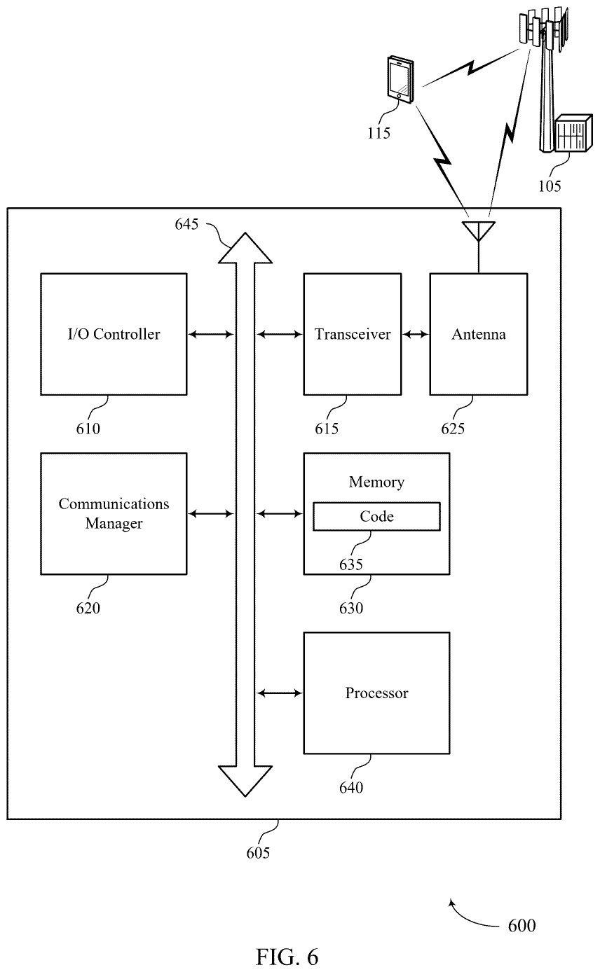

FIG. 6 shows a diagram of a system 600 including a device 605 that supports downlink control channel design and signaling in accordance with one or more aspects of the present disclosure. The device 605 may be an example of or include components of a device 305, a device 405, or a UE 115 as described herein. The device 605 may communicate (e.g., wirelessly) with one or more other devices (e.g., network entities 105, UEs 115, or a combination thereof). The device 605 may include components for bi-directional voice and data communications including components for transmitting and receiving communications, such as a communications manager 620, an input/output (I/O) controller, such as an I/O controller 610, a transceiver 615, one or more antennas 625, at least one memory 630, code 635, and at least one processor 640. These components may be in electronic communication or otherwise coupled (e.g., operatively, communicatively, functionally, electronically, electrically) via one or more buses (e.g., a bus 645).

The I/O controller 610 may manage input and output signals for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. Additionally, or alternatively, the I/O controller 610 may represent or interact with a modem, a keyboard, a mouse, a touchscreen, or a similar device. In some cases, the I/O controller 610 may be implemented as part of one or more processors, such as the at least one processor 640. In some cases, a user may interact with the device 605 via the I/O controller 610 or via hardware components controlled by the I/O controller 610.

In some cases, the device 605 may include a single antenna. However, in some other cases, the device 605 may have more than one antenna, which may be capable of concurrently transmitting or receiving multiple wireless transmissions. The transceiver 615 may communicate bi-directionally via the one or more antennas 625 using wired or wireless links as described herein. For example, the transceiver 615 may represent a wireless transceiver and may communicate bi-directionally with another wireless transceiver. The transceiver 615 may also include a modem to modulate the packets, to provide the modulated packets to one or more antennas 625 for transmission, and to demodulate packets received from the one or more antennas 625. The transceiver 615, or the transceiver 615 and one or more antennas 625, may be an example of a transmitter 315, a transmitter 415, a receiver 310, a receiver 410, or any combination thereof or component thereof, as described herein.

The at least one memory 630 may include random access memory (RAM) and read-only memory (ROM). The at least one memory 630 may store computer-readable, computer-executable, or processor-executable code, such as the code 635. The code 635 may include instructions that, when executed by the at least one processor 640, cause the device 605 to perform various functions described herein. The code 635 may be stored in a non-transitory computer-readable medium such as system memory or another type of memory. In some cases, the code 635 may not be directly executable by the at least one processor 640 but may cause a computer (e.g., when compiled and executed) to perform functions described herein. In some cases, the at least one memory 630 may include, among other things, a basic I/O system (BIOS) which may control basic hardware or software operation such as the interaction with peripheral components or devices.

The at least one processor 640 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 640 may be configured to operate a memory array using a memory controller. In some other cases, a memory controller may be integrated into the at least one processor 640. The at least one processor 640 may be configured to execute computer-readable instructions stored in a memory (e.g., the at least one memory 630) to cause the device 605 to perform various functions (e.g., functions or tasks supporting downlink control channel design and signaling). For example, the device 605 or a component of the device 605 may include at least one processor 640 and at least one memory 630 coupled with or to the at least one processor 640, the at least one processor 640 and the at least one memory 630 configured to perform various functions described herein.

In some examples, the at least one processor 640 may include multiple processors and the at least one memory 630 may include multiple memories. One or more of the multiple processors may be coupled with one or more of the multiple memories, which may, individually or collectively, be configured to perform various functions described herein. In some examples, the at least one processor 640 may be a component of a processing system, which may refer to a system (such as a series) of machines, circuitry (including, for example, one or both of processor circuitry (which may include the at least one processor 640) and memory circuitry (which may include the at least one memory 630)), or components, that receives or obtains inputs and processes the inputs to produce, generate, or obtain a set of outputs. The processing system may be configured to perform one or more of the functions described herein. For example, the at least one processor 640 or a processing system including the at least one processor 640 may be configured to, configurable to, or operable to cause the device 605 to perform one or more of the functions described herein. Further, as described herein, being “configured to,” being “configurable to,” and being “operable to” may be used interchangeably and may be associated with a capability, when executing code 635 (e.g., processor-executable code) stored in the at least one memory 630 or otherwise, to perform one or more of the functions described herein.

The communications manager 620 may support wireless communications in accordance with examples as disclosed herein. For example, the communications manager 620 is capable of, configured to, or operable to support a means for receiving control signaling indicating a set of parameters for one or more control channels, the set of parameters including a modulation and coding scheme table for a first control channel, a quantity of resource blocks per control channel element for the first control channel, or both. The communications manager 620 is capable of, configured to, or operable to support a means for receiving a control information message via the first control channel in accordance with the set of parameters, where a subset of control information corresponding to the control information message is indicated by an index value in the control information message, or is fixed and excluded from the control information message. The communications manager 620 is capable of, configured to, or operable to support a means for performing wireless communication via a shared channel in accordance with the control information message.

By including or configuring the communications manager 620 in accordance with examples as described herein, the device 605 may support techniques for control signaling resulting in improved throughput, decreased system latency, reduced processing, reduced power consumption, decreased system latency, improved coordination between devices, longer battery life, more efficient utilization of communication resources, and improved user experience.

In some examples, the communications manager 620 may be configured to perform various operations (e.g., receiving, monitoring, transmitting) using or otherwise in cooperation with the transceiver 615, the one or more antennas 625, or any combination thereof. Although the communications manager 620 is illustrated as a separate component, in some examples, one or more functions described with reference to the communications manager 620 may be supported by or performed by the at least one processor 640, the at least one memory 630, the code 635, or any combination thereof. For example, the code 635 may include instructions executable by the at least one processor 640 to cause the device 605 to perform various aspects of downlink control channel design and signaling as described herein, or the at least one processor 640 and the at least one memory 630 may be otherwise configured to, individually or collectively, perform or support such operations.

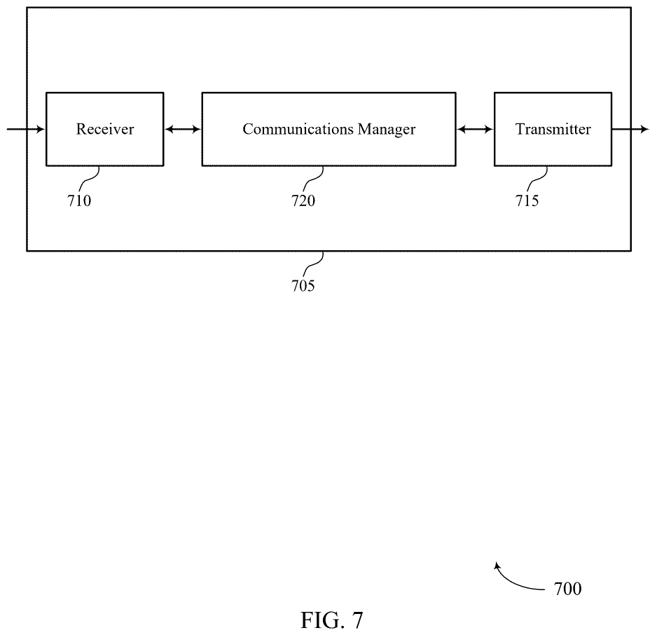

FIG. 7 shows a block diagram 700 of a device 705 that supports downlink control channel design and signaling in accordance with one or more aspects of the present disclosure. The device 705 may be an example of aspects of a network entity 105 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The communications manager 720, the receiver 710, the transmitter 715, or various combinations or components thereof may be examples of means for performing various aspects of downlink control channel design and signaling as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for transmitting control signaling indicating a set of parameters for one or more control channels, the set of parameters including a modulation and coding scheme table for a first control channel, a quantity of resource blocks per control channel element for the first control channel, or both. The communications manager 720 is capable of, configured to, or operable to support a means for transmitting a control information message via the first control channel in accordance with the set of parameters, where a subset of control information corresponding to the control information message is indicated by an index value in the control information message, or is fixed and excluded from the control information message. The communications manager 720 is capable of, configured to, or operable to support a means for performing wireless communication via a shared channel in accordance with the control information message.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for control signaling resulting in improved throughput, decreased system latency, reduced processing, reduced power consumption, and more efficient utilization of communication resources.

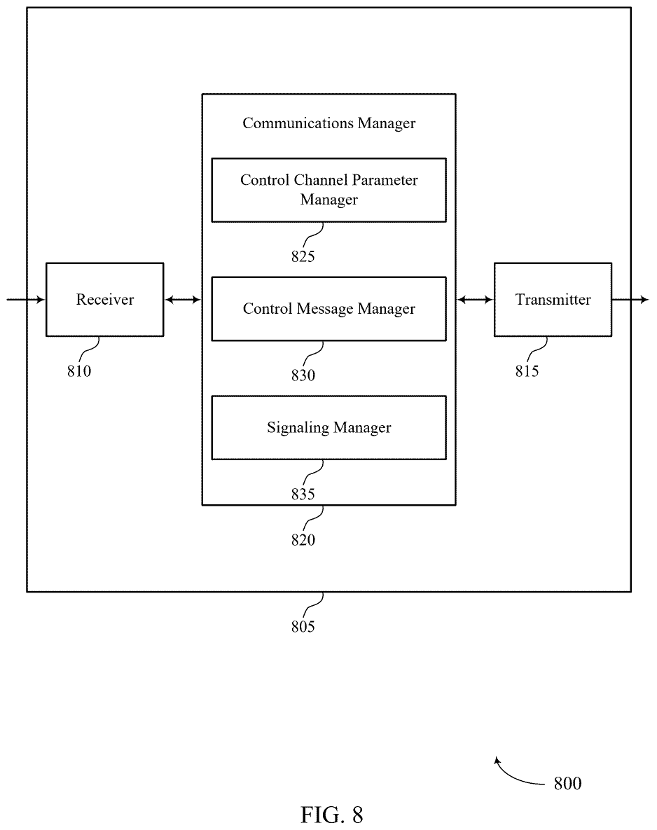

FIG. 8 shows a block diagram 800 of a device 805 that supports downlink control channel design and signaling in accordance with one or more aspects of the present disclosure. The device 805 may be an example of aspects of a device 705 or a network entity 105 as described herein. The device 805 may include a receiver 810, a transmitter 815, and a communications manager 820. The device 805, or one of more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The device 805, or various components thereof, may be an example of means for performing various aspects of downlink control channel design and signaling as described herein. For example, the communications manager 820 may include a control channel parameter manager 825, a control message manager 830, a signaling manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The control channel parameter manager 825 is capable of, configured to, or operable to support a means for transmitting control signaling indicating a set of parameters for one or more control channels, the set of parameters including a modulation and coding scheme table for a first control channel, a quantity of resource blocks per control channel element for the first control channel, or both. The control message manager 830 is capable of, configured to, or operable to support a means for transmitting a control information message via the first control channel in accordance with the set of parameters, where a subset of control information corresponding to the control information message is indicated by an index value in the control information message, or is fixed and excluded from the control information message. The signaling manager 835 is capable of, configured to, or operable to support a means for performing wireless communication via a shared channel in accordance with the control information message.

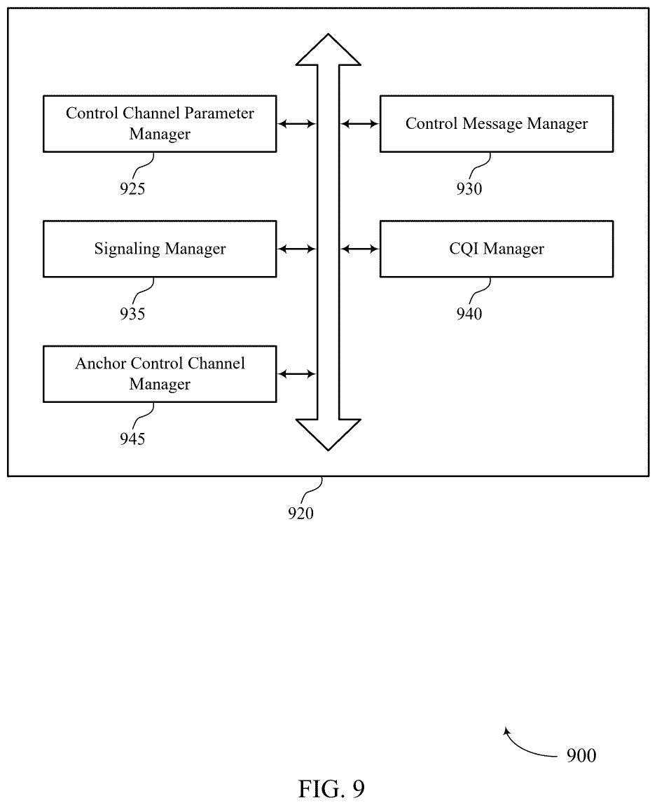

FIG. 9 shows a block diagram 900 of a communications manager 920 that supports downlink control channel design and signaling in accordance with one or more aspects of the present disclosure. The communications manager 920 may be an example of aspects of a communications manager 720, a communications manager 820, or both, as described herein. The communications manager 920, or various components thereof, may be an example of means for performing various aspects of downlink control channel design and signaling as described herein. For example, the communications manager 920 may include a control channel parameter manager 925, a control message manager 930, a signaling manager 935, a CQI manager 940, an anchor control channel manager 945, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 920 may support wireless communications in accordance with examples as disclosed herein. The control channel parameter manager 925 is capable of, configured to, or operable to support a means for transmitting control signaling indicating a set of parameters for one or more control channels, the set of parameters including a modulation and coding scheme table for a first control channel, a quantity of resource blocks per control channel element for the first control channel, or both. The control message manager 930 is capable of, configured to, or operable to support a means for transmitting a control information message via the first control channel in accordance with the set of parameters, where a subset of control information corresponding to the control information message is indicated by an index value in the control information message, or is fixed and excluded from the control information message. The signaling manager 935 is capable of, configured to, or operable to support a means for performing wireless communication via a shared channel in accordance with the control information message.

In some examples, the quantity of resource blocks per control channel element includes a fraction of a default control channel element size or is indicated by the modulation and coding scheme table for the first control channel. In some examples, a second control channel corresponds to the default control channel element size.

In some examples, the quantity of resource blocks per control channel element is configured per band or bandwidth part.

In some examples, the CQI manager 940 is capable of, configured to, or operable to support a means for receiving a channel quality information corresponding to the first control channel, the channel quality information including a report margin or a deficit corresponding to decoding the control information message.

In some examples, the subset of control information includes frequency domain resource allocation, modulation and coding scheme information, feedback information identifiers, timing offset information, or any combination thereof.

In some examples, the anchor control channel manager 945 is capable of, configured to, or operable to support a means for transmitting the control information message via an anchor control channel corresponding to a default control channel element size, a default control information message size, or both.

In some examples, the first control channel includes a downlink control channel, and the control information message includes a downlink control information message.

In some examples, the first control channel includes a sidelink control channel, and the control information message includes a sidelink control information message.

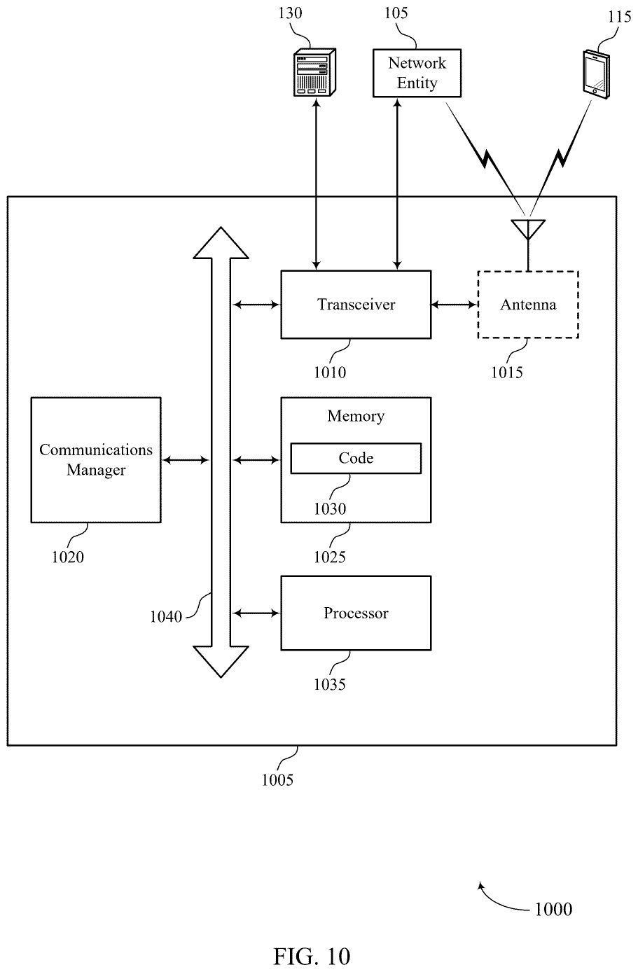

FIG. 10 shows a diagram of a system 1000 including a device 1005 that supports downlink control channel design and signaling in accordance with one or more aspects of the present disclosure. The device 1005 may be an example of or include components of a device 705, a device 805, or a network entity 105 as described herein. The device 1005 may communicate with other network devices or network equipment such as one or more of the network entities 105, UEs 115, or any combination thereof. The communications may include communications over one or more wired interfaces, over one or more wireless interfaces, or any combination thereof. The device 1005 may include components that support outputting and obtaining communications, such as a communications manager 1020, a transceiver 1010, one or more antennas 1015, at least one memory 1025, code 1030, and at least one processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or one or more memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or one or more memory components (e.g., the at least one processor 1035, the at least one memory 1025, or both), may be included in a chip or chip assembly that is installed in the device 1005. In some examples, the transceiver 1010 may be operable to support communications via one or more communications links (e.g., communication link(s) 125, backhaul communication link(s) 120, a midhaul communication link 162, a fronthaul communication link 168).

The at least one memory 1025 may include RAM, ROM, or any combination thereof. The at least one memory 1025 may store computer-readable, computer-executable, or processor-executable code, such as the code 1030. The code 1030 may include instructions that, when executed by one or more of the at least one processor 1035, cause the device 1005 to perform various functions described herein. The code 1030 may be stored in a non-transitory computer-readable medium such as system memory or another type of memory. In some cases, the code 1030 may not be directly executable by a processor of the at least one processor 1035 but may cause a computer (e.g., when compiled and executed) to perform functions described herein. In some cases, the at least one memory 1025 may include, among other things, a BIOS which may control basic hardware or software operation such as the interaction with peripheral components or devices. In some examples, the at least one processor 1035 may include multiple processors and the at least one memory 1025 may include multiple memories. One or more of the multiple processors may be coupled with one or more of the multiple memories which may, individually or collectively, be configured to perform various functions herein (for example, as part of a processing system).

The at least one processor 1035 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1035 may be configured to operate a memory array using a memory controller. In some other cases, a memory controller may be integrated into one or more of the at least one processor 1035. The at least one processor 1035 may be configured to execute computer-readable instructions stored in a memory (e.g., one or more of the at least one memory 1025) to cause the device 1005 to perform various functions (e.g., functions or tasks supporting downlink control channel design and signaling). For example, the device 1005 or a component of the device 1005 may include at least one processor 1035 and at least one memory 1025 coupled with one or more of the at least one processor 1035, the at least one processor 1035 and the at least one memory 1025 configured to perform various functions described herein. The at least one processor 1035 may be an example of a cloud-computing platform (e.g., one or more physical nodes and supporting software such as operating systems, virtual machines, or container instances) that may host the functions (e.g., by executing code 1030) to perform the functions of the device 1005. The at least one processor 1035 may be any one or more suitable processors capable of executing scripts or instructions of one or more software programs stored in the device 1005 (such as within one or more of the at least one memory 1025).

In some examples, the at least one processor 1035 may include multiple processors and the at least one memory 1025 may include multiple memories. One or more of the multiple processors may be coupled with one or more of the multiple memories, which may, individually or collectively, be configured to perform various functions herein. In some examples, the at least one processor 1035 may be a component of a processing system, which may refer to a system (such as a series) of machines, circuitry (including, for example, one or both of processor circuitry (which may include the at least one processor 1035) and memory circuitry (which may include the at least one memory 1025)), or components, that receives or obtains inputs and processes the inputs to produce, generate, or obtain a set of outputs. The processing system may be configured to perform one or more of the functions described herein. For example, the at least one processor 1035 or a processing system including the at least one processor 1035 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1025 or otherwise, to perform one or more of the functions described herein.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the at least one memory 1025, the code 1030, and the at least one processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with one or more other network entities 105, and may include a controller or scheduler for controlling communications with UEs 115 (e.g., in cooperation with the one or more other network devices). In some examples, the communications manager 1020 may support an X2 interface within an LTE/LTE-A wireless communications network technology to provide communication between network entities 105.

The communications manager 1020 may support wireless communications in accordance with examples as disclosed herein. For example, the communications manager 1020 is capable of, configured to, or operable to support a means for transmitting control signaling indicating a set of parameters for one or more control channels, the set of parameters including a modulation and coding scheme table for a first control channel, a quantity of resource blocks per control channel element for the first control channel, or both. The communications manager 1020 is capable of, configured to, or operable to support a means for transmitting a control information message via the first control channel in accordance with the set of parameters, where a subset of control information corresponding to the control information message is indicated by an index value in the control information message, or is fixed and excluded from the control information message. The communications manager 1020 is capable of, configured to, or operable to support a means for performing wireless communication via a shared channel in accordance with the control information message.

By including or configuring the communications manager 1020 in accordance with examples as described herein, the device 1005 may support techniques for control signaling resulting in improved throughput, decreased system latency, reduced processing, reduced power consumption, decreased system latency, improved coordination between devices, longer battery life, more efficient utilization of communication resources, and improved user experience.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, one or more of the at least one processor 1035, one or more of the at least one memory 1025, the code 1030, or any combination thereof (for example, by a processing system including at least a portion of the at least one processor 1035, the at least one memory 1025, the code 1030, or any combination thereof). For example, the code 1030 may include instructions executable by one or more of the at least one processor 1035 to cause the device 1005 to perform various aspects of downlink control channel design and signaling as described herein, or the at least one processor 1035 and the at least one memory 1025 may be otherwise configured to, individually or collectively, perform or support such operations.

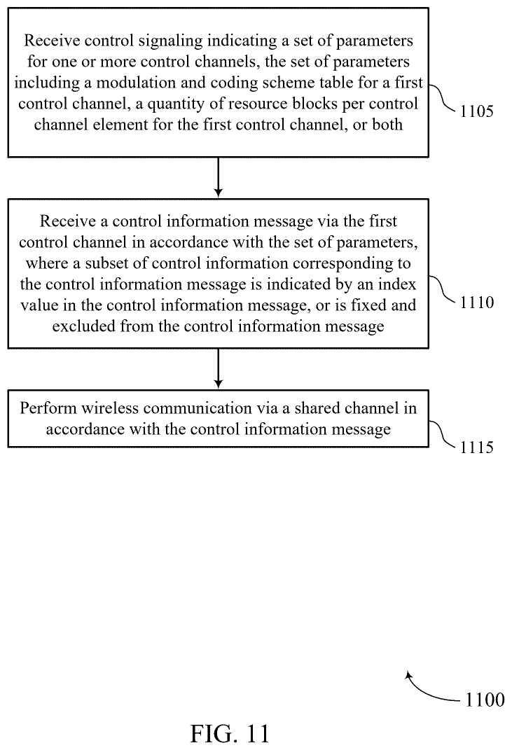

FIG. 11 shows a flowchart illustrating a method 1100 that supports downlink control channel design and signaling in accordance with one or more aspects of the present disclosure. The operations of the method 1100 may be implemented by a UE or its components as described herein. For example, the operations of the method 1100 may be performed by a UE 115 as described with reference to FIGS. 1 through 6. In some examples, a UE may execute a set of instructions to control the functional elements of the UE to perform the described functions. Additionally, or alternatively, the UE may perform aspects of the described functions using special-purpose hardware.

At 1105, the method may include receiving control signaling indicating a set of parameters for one or more control channels, the set of parameters including a modulation and coding scheme table for a first control channel, a quantity of resource blocks per control channel element for the first control channel, or both. The operations of 1105 may be performed in accordance with examples as disclosed herein. In some examples, aspects of the operations of 1105 may be performed by a control channel parameter manager 525 as described with reference to FIG. 5.

At 1110, the method may include receiving a control information message via the first control channel in accordance with the set of parameters, where a subset of control information corresponding to the control information message is indicated by an index value in the control information message, or is fixed and excluded from the control information message. The operations of 1110 may be performed in accordance with examples as disclosed herein. In some examples, aspects of the operations of 1110 may be performed by a control message manager 530 as described with reference to FIG. 5.

At 1115, the method may include performing wireless communication via a shared channel in accordance with the control information message. The operations of 1115 may be performed in accordance with examples as disclosed herein. In some examples, aspects of the operations of 1115 may be performed by a signaling manager 535 as described with reference to FIG. 5.

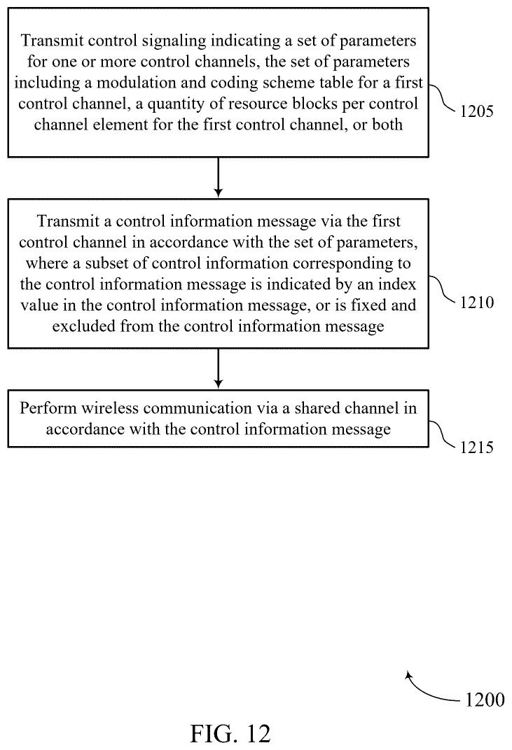

FIG. 12 shows a flowchart illustrating a method 1200 that supports downlink control channel design and signaling in accordance with one or more aspects of the present disclosure. The operations of the method 1200 may be implemented by a network entity or its components as described herein. For example, the operations of the method 1200 may be performed by a network entity as described with reference to FIGS. 1 and 2 and 7 through 10. In some examples, a network entity may execute a set of instructions to control the functional elements of the network entity to perform the described functions. Additionally, or alternatively, the network entity may perform aspects of the described functions using special-purpose hardware.

At 1205, the method may include transmitting control signaling indicating a set of parameters for one or more control channels, the set of parameters including a modulation and coding scheme table for a first control channel, a quantity of resource blocks per control channel element for the first control channel, or both. The operations of 1205 may be performed in accordance with examples as disclosed herein. In some examples, aspects of the operations of 1205 may be performed by a control channel parameter manager 925 as described with reference to FIG. 9.

At 1210, the method may include transmitting a control information message via the first control channel in accordance with the set of parameters, where a subset of control information corresponding to the control information message is indicated by an index value in the control information message, or is fixed and excluded from the control information message. The operations of 1210 may be performed in accordance with examples as disclosed herein. In some examples, aspects of the operations of 1210 may be performed by a control message manager 930 as described with reference to FIG. 9.

At 1215, the method may include performing wireless communication via a shared channel in accordance with the control information message. The operations of 1215 may be performed in accordance with examples as disclosed herein. In some examples, aspects of the operations of 1215 may be performed by a signaling manager 935 as described with reference to FIG. 9.

The following provides an overview of aspects of the present disclosure:

Aspect 1: A method for wireless communications at a UE, comprising: receiving control signaling indicating a set of parameters for one or more control channels, the set of parameters comprising a modulation and coding scheme table for a first control channel, a quantity of resource blocks per control channel element for the first control channel, or both; receiving a control information message via the first control channel in accordance with the set of parameters, wherein a subset of control information corresponding to the control information message is indicated by an index value in the control information message, or is fixed and excluded from the control information message; and performing wireless communication via a shared channel in accordance with the control information message.

Aspect 2: The method of aspect 1, wherein the quantity of resource blocks per control channel element comprises a fraction of a default control channel element size or is indicated by the modulation and coding scheme table for the first control channel, a second control channel corresponds to the default control channel element size.

Aspect 3: The method of any of aspects 1 through 2, wherein the quantity of resource blocks per control channel element is configured per band or bandwidth part.

Aspect 4: The method of any of aspects 1 through 3, further comprising: decoding the control information message; and transmitting a channel quality information corresponding to the first control channel, the channel quality information comprising a report margin or a deficit corresponding to the decoding.

Aspect 5: The method of any of aspects 1 through 4, wherein the subset of control information comprises frequency domain resource allocation, modulation and coding scheme information, feedback information identifiers, timing offset information, or any combination thereof.

Aspect 6: The method of any of aspects 1 through 5, further comprising: receiving or recovering the control information message via an anchor control channel corresponding to a default control channel element size, a default control information message size, or both.

Aspect 7: The method of any of aspects 1 through 6, wherein the first control channel comprises a downlink control channel, and the control information message comprises a downlink control information message.

Aspect 8: The method of any of aspects 1 through 7, wherein the first control channel comprises a sidelink control channel, and the control information message comprises a sidelink control information message.

Aspect 9: A method for wireless communications, comprising: transmitting control signaling indicating a set of parameters for one or more control channels, the set of parameters comprising a modulation and coding scheme table for a first control channel, a quantity of resource blocks per control channel element for the first control channel, or both; transmitting a control information message via the first control channel in accordance with the set of parameters, wherein a subset of control information corresponding to the control information message is indicated by an index value in the control information message, or is fixed and excluded from the control information message; and performing wireless communication via a shared channel in accordance with the control information message.

Aspect 10: The method of aspect 9, wherein the quantity of resource blocks per control channel element comprises a fraction of a default control channel element size or is indicated by the modulation and coding scheme table for the first control channel, a second control channel corresponds to the default control channel element size.

Aspect 11: The method of any of aspects 9 through 10, wherein the quantity of resource blocks per control channel element is configured per band or bandwidth part.

Aspect 12: The method of any of aspects 9 through 11, further comprising: receiving a channel quality information corresponding to the first control channel, the channel quality information comprising a report margin or a deficit corresponding to decoding the control information message.

Aspect 13: The method of any of aspects 9 through 12, wherein the subset of control information comprises frequency domain resource allocation, modulation and coding scheme information, feedback information identifiers, timing offset information, or any combination thereof.

Aspect 14: The method of any of aspects 9 through 13, further comprising: transmitting the control information message via an anchor control channel corresponding to a default control channel element size, a default control information message size, or both.

Aspect 15: The method of any of aspects 9 through 14, wherein the first control channel comprises a downlink control channel, and the control information message comprises a downlink control information message.

Aspect 16: The method of any of aspects 9 through 15, wherein the first control channel comprises a sidelink control channel, and the control information message comprises a sidelink control information message.

Aspect 17: A UE for wireless communications, comprising one or more memories, a transceiver, and one or more processors coupled with the one or more memories and the transceiver, and individually or collectively configured to perform a method of any of aspects 1 through 8.

Aspect 18: A UE for wireless communications, comprising at least one means for performing a method of any of aspects 1 through 8.

Aspect 19: A non-transitory computer-readable medium storing code for wireless communications, the code comprising instructions executable by one or more processors to perform a method of any of aspects 1 through 8.

Aspect 20: An apparatus for wireless communications, comprising one or more memories storing processor-executable code, and one or more processors coupled with the one or more memories and individually or collectively configured to perform a method of any of aspects 9 through 16.

Aspect 21: An apparatus for wireless communications, comprising at least one means for performing a method of any of aspects 9 through 16.

Aspect 22: A non-transitory computer-readable medium storing code for wireless communications, the code comprising instructions executable by one or more processors to perform a method of any of aspects 9 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories;
a transceiver; and
one or more processors coupled with the one or more memories and the transceiver, the one or more processors individually or collectively configured to:
receive, via the transceiver, control signaling indicating a set of parameters for one or more control channels, the set of parameters comprising a modulation and coding scheme table for a first control channel, a quantity of resource blocks per control channel element for the first control channel, or both;
receive, via the transceiver, a control information message via the first control channel in accordance with the set of parameters, wherein a subset of control information corresponding to the control information message is indicated by an index value in the control information message, or is fixed and excluded from the control information message; and
perform, via the transceiver, wireless communication via a shared channel in accordance with the control information message.

2. The UE of claim 1, wherein the quantity of resource blocks per control channel element comprises a fraction of a default control channel element size or is indicated by the modulation and coding scheme table for the first control channel, and a second control channel corresponds to the default control channel element size.

3. The UE of claim 1, wherein the quantity of resource blocks per control channel element is configured per band or bandwidth part.

4. The UE of claim 1, wherein the one or more processors are individually or collectively further configured to:
decode the control information message; and
transmit, via the transceiver, a channel quality information corresponding to the first control channel, the channel quality information comprising a report margin or a deficit corresponding to the decoding.

5. The UE of claim 1, wherein the subset of control information comprises frequency domain resource allocation, modulation and coding scheme information, feedback information identifiers, timing offset information, or any combination thereof.

6. The UE of claim 1, wherein the one or more processors are individually or collectively further configured to:
receive, via the transceiver, or recover the control information message via an anchor control channel corresponding to a default control channel element size, a default control information message size, or both.

7. The UE of claim 1, wherein the first control channel comprises a downlink control channel, and the control information message comprises a downlink control information message.

8. The UE of claim 1, wherein the first control channel comprises a sidelink control channel, and the control information message comprises a sidelink control information message.

9. An apparatus, comprising:
one or more memories; and
one or more processors coupled with the one or more memories and individually or collectively configured to:
transmit control signaling indicating a set of parameters for one or more control channels, the set of parameters comprising a modulation and coding scheme table for a first control channel, a quantity of resource blocks per control channel element for the first control channel, or both;
transmit a control information message via the first control channel in accordance with the set of parameters, wherein a subset of control information corresponding to the control information message is indicated by an index value in the control information message, or is fixed and excluded from the control information message; and
perform wireless communication via a shared channel in accordance with the control information message.

10. The apparatus of claim 9, wherein the quantity of resource blocks per control channel element comprises a fraction of a default control channel element size or is indicated by the modulation and coding scheme table for the first control channel, and a second control channel corresponds to the default control channel element size.

11. The apparatus of claim 9, wherein the quantity of resource blocks per control channel element is configured per band or bandwidth part.

12. The apparatus of claim 9, wherein the one or more processors are individually or collectively further configured to:
receive a channel quality information corresponding to the first control channel, the channel quality information comprising a report margin or a deficit corresponding to decoding the control information message.

13. The apparatus of claim 9, wherein the subset of control information comprises frequency domain resource allocation, modulation and coding scheme information, feedback information identifiers, timing offset information, or any combination thereof.

14. The apparatus of claim 9, wherein the one or more processors are individually or collectively further configured to:
transmit the control information message via an anchor control channel corresponding to a default control channel element size, a default control information message size, or both.

15. The apparatus of claim 9, wherein the first control channel comprises a downlink control channel, and the control information message comprises a downlink control information message.

16. The apparatus of claim 9, wherein the first control channel comprises a sidelink control channel, and the control information message comprises a sidelink control information message.

17. A method for wireless communications at a user equipment (UE), comprising:
receiving control signaling indicating a set of parameters for one or more control channels, the set of parameters comprising a modulation and coding scheme table for a first control channel, a quantity of resource blocks per control channel element for the first control channel, or both;
receiving a control information message via the first control channel in accordance with the set of parameters, wherein a subset of control information corresponding to the control information message is indicated by an index value in the control information message, or is fixed and excluded from the control information message; and
performing wireless communication via a shared channel in accordance with the control information message.

18. The method of claim 17, wherein the quantity of resource blocks per control channel element comprises a fraction of a default control channel element size or is indicated by the modulation and coding scheme table for the first control channel, and a second control channel corresponds to the default control channel element size.

19. The method of claim 17, wherein the quantity of resource blocks per control channel element is configured per band or bandwidth part.

20. The method of claim 17, further comprising:
decoding the control information message; and
transmitting a channel quality information corresponding to the first control channel, the channel quality information comprising a report margin or a deficit corresponding to the decoding.
